(19) United States
(12) Patent Application Publication
(10) Pub. No.: US 2005/0275721 A1
(43) Pub. Date: Dec. 15, 2005

(54) Monitor system for monitoring suspicious object

(76) Inventor: Yusuke Ishii, Yokohama-shi (JP)

Correspondence Address: NATH & ASSOCIATES, PLLC, Sixth Floor, 1030 15th Street, N.W., Washington, DC, 20005, US

(21) Appl. No.: 11/150,264

(22) Filed: Jun. 13, 2005

(30) Foreign Application Priority Data
Jun. 14, 2004 (JP) P2004-176090
Mar. 29, 2005 (JP) P2005-095885

(51) Int. Cl. H04N 9/74

(52) U.S. Cl. 348/159; 348/143

(57) ABSTRACT

A monitor camera photographs a whole monitor area for capturing the photographed whole monitor area as high definition image data higher in resolution than a display screen. A new object detection/extraction unit detects a new object in the monitor area based on the high definition image data captured by the monitor camera, extracts partial image data of an area, which contains the new object, from the high definition image data, and obtains location information on the partial image data in relation to the high definition image data. A whole-monitor-area image data down-sampling unit down-samples the high definition image data to produce standard definition image data corresponding to the resolution of the display screen. An image enlargement unit enlarges the standard definition image data based on entered enlargement instruction information. An image combination unit overlaps the partial image data on image data, enlarged by the image enlargement unit, based on the location information and sends resulting image data to the display screen.

### BACKGROUND OF THE INVENTION

1. Field of the Invention

The present invention relates to a monitor system installed in a large store, a recreational facility, and so on, and more particularly to a low-cost configuration monitor system capable of enlarging one or more monitor objects, which appear in a monitor area, at a high resolution for monitoring.

2. Description of the Related Art

A monitor video camera system in a large store or a recreational facility is required to cover a wide range with a smaller number of monitor cameras from the viewpoint of economy but is preferably required to have many monitor cameras per unit area from the viewpoint of monitoring accuracy based on detailed videos.

However, they are conflicting requirements. That is, if an event requiring careful attention occurs in a place where a single monitor camera is installed to cover a wide range, the part of a video requiring careful attention sometimes has a resolution that is too low to be useful. On the other hand, many monitor cameras, if installed per unit area, would require an additional cost of not only the monitor cameras but also various connection devices and recording devices and, in addition, increase the cost for installing those devices.

An object tracking-type monitor video camera system was developed to solve this situation.

Conventionally, the simplest object tracking-type monitor video camera system has a zoom camera installed on the platform of a mechanical pan/tilt mechanism (rotation, elevation mechanism) for tracking an object (human face, human body, car, etc.). To track down a target object, the object tracking-type video camera system first captures the video of the whole monitor area on the wide-angle side of the zoom lens, performs image processing for the captured image to identify the object, and identifies the location of the object. After that, the object tracking-type video camera system tracks the object by activating the pan/tilt mechanism according to the movement of the object as the time goes on.

However, such an object tracking-type video camera system is required to do the wide-angle operation and the telescopic operation repeatedly to continuously capture a moving object and, so, its tracking performance is not so high. In addition, an extreme zoom operation, if performed for an object, makes a security guard fail to identify the relative location of the object relative to the background video (monitor area) and puts the security guard into confusion.

To solve the problem of tracking performance and operational performance, two cameras are required: one is a fixed camera with a wide-angle lens for capturing the whole monitor area and the other is a tracking camera for tracking an object. That is, the fixed camera is used first to capture the whole monitor area. Then, for the captured whole image information, image processing such as moving-object detection and human-face detection is performed to identify the location of an object. Once the location of the object is identified, the tracking camera is used to track the object while zooming it in.

For example, Japanese Patent Laid-Open Publication No. 2004-7374 discloses a system, which has a wide-angle camera A and a camera B with the pan/tilt function, for detecting a moving object in an image captured by the wide-lens camera and for tracking the detected moving object with the camera B. This system is particularly configured to output an alarm signal while the camera B is tracking a moving object so that the security guard is requited to monitor the screen only when the alarm is sound.

However, when a wide-angle camera and a tracking camera are used as separate cameras to track one object, they tend to generate an accuracy problem in the tracking control signal supplied from the wide-angle camera to the tracking camera. That is, unless the optical axes of the lenses of the two cameras almost coincide, the object coordinate information given to the tracking camera does not always match the coordinate information on the wide-angle camera and, therefore, the object cannot be captured accurately. In addition, because there are many practical problems including the limitation on the installation location, it is not easy to determine the installation location satisfying the desired operation conditions.

In addition, though the tracking-type monitor video camera system described above assumes that there is only one object to be tracked, there are practically few environments in which there is only one object (object to be tracked); instead, there are many more environments in which a plurality of persons, cars, and other objects must be tracked, monitored, and recorded at the same time. Therefore, in such an environment, the object tracking-type monitor video camera system described above, which basically assumes only one object to be tracked, cannot achieve the object.

To make the system compatible with an environment in which there are a plurality of objects to be tracked, a plurality of tracking cameras should be provided considering the number of objects to be tracked.

However, considering the costs of the monitor cameras, camera connection devices, and recording devices as well as the installation cost of those devices, providing a plurality of tracking cameras would greatly increase the cost of the whole system with the result that building such a system becomes impractical.

Meanwhile, from the viewpoint of image processing load, the amount of image data to be processed should preferably be as small as possible. That is, the required information can be acquired by capturing a monitor area with a high definition video camera and then by processing and recording the acquired image information. However, such a system generates a huge amount of information and makes it difficult to monitor and record information for a long time.

A prior art technology for reducing the amount of image data processing is disclosed in Japanese Patent Laid-Open Publication No. 2003-339047. That is, Japanese Patent Laid-Open Publication No. 2003-339047 discloses a technology that allows the user of an image to specify a target image of the image and to set a quantization rate, different from that of other areas, for the specified target area. By doing so, this technology controls image compression based on the specified quantization rate and compresses the image according to the user's request.

However, this technology is not related to a monitor device and, therefore, does not suggest any solution for reducing the amount of image processing data in the technology for tracking a moving object.

Meanwhile, when a monitor object (an object to be tracked) appears in the monitor area, a monitor should preferably enlarge the object immediately for observation. Also, a monitor device should preferably enlarge the object at a desired resolution for observation. To meet those needs, a high-precision sensor (CCD) is used recently for the monitor camera of the monitor device. On the other hand, the monitor camera of an object tracking-type monitor camera system is usually connected to a communication network for transmission of a monitor video to a remote terminal. Therefore, if an existing communication network is used, the problem is that the processing speed of the whole system is not increased due to the transmission capacity of the communication network even if a very high-precision sensor is used.

To view an object at a desired resolution on the monitor side, it is necessary to provide a memory in which a video, received from a high-definition object tracking-type monitor camera, is once stored and to re-edit the object at a desired resolution. This increases the cost of the monitor side.

### SUMMARY OF THE INVENTION

In view of the foregoing, it is an object of the present invention to provide a low-cost configuration monitor system capable of enlarging one or more monitor objects, which appear in a monitor area, at a high resolution for monitoring.

More specifically, it is an object of the present invention to provide a monitor system capable of displaying one or more monitor objects without decreasing the resolution even if they are enlarged.

Still, more specifically, it is an object of the present invention to provide a monitor system capable of tracking a plurality of monitor objects with one camera.

To achieve the above objects, there is provided a monitor system comprising: a display screen (209) on which image data is displayed; a high definition camera (1) that photographs a whole monitor area for capturing the photographed whole monitor area as high definition image data higher in resolution than the display screen; an object detection/extraction unit (202) that detects a new object in the monitor area based on the high definition image data captured by the high definition camera (1), extracts partial image data of an area, which contains the new object, from the high definition image data, and obtains location information on the partial image data in relation to the high definition image data; a whole image data down-sampling unit (203) that down-samples the high definition image data to produce standard definition image data corresponding to the resolution of the display screen (209); an image enlargement unit (207) that enlarges the standard definition image data based on entered enlargement instruction information (EL); and an image combination unit (208) that overlaps the partial image data on image data, enlarged by the image enlargement unit (207), based on the location information and sends resulting image data to the display screen (209).

According to the present invention, one high definition camera can be used to view the image of the whole monitor area in the normal operation status and, as necessary, to enlarge and view a partial area, especially, a new object, without decreasing the resolution.

In a preferred embodiment of the present invention, when a plurality of new objects are detected in the monitor area, the object detection/extraction unit (202) extracts a plurality of pieces of partial image data in a plurality of areas, each of which contains one of the plurality of new objects, from the high definition image data and obtains a plurality of pieces of location information on the high definition image data of the plurality of pieces of partial image data.

According to this embodiment, even if a plurality of new objects appear in the monitor area, one high definition camera can be used to enlarge and view the new objects without decreasing the resolution.

In a preferred embodiment of the present invention, the image enlargement unit (207) enlarges the standard definition image data according to a ratio of a definition level of the high definition image data to the resolution of the display screen.

According to this embodiment, a new object can be fully enlarged according to the ratio of the definition level of high definition image data to the resolution of the display screen.

In a preferred embodiment of the present invention, the monitor system further comprises a partial image data down-sampling unit (213a, 213b) that down-samples the partial image data, extracted by the object detection/extraction unit (202), and sends the down-sampled partial image data to the image combination unit (208), wherein the image enlargement unit (207) enlarges the standard definition image data according to enlargement rate information included in the enlargement instruction information and the partial image data down-sampling unit (213a, 213b) down-samples the partial image data according to the enlargement rate information.

According to this embodiment, a new object can be displayed at any enlargement rate without decreasing the resolution.

In a preferred embodiment of the present invention, the object detection/extraction unit (202) obtains the partial image data and the location information at each predetermined time and the whole image data down-sampling unit (203) obtains the standard definition image data at the each predetermined time, and the monitor system further comprises an image data storage unit (204, 205) in which the standard definition image data, the partial image data, and the location information are stored, the standard definition image data, the partial image data, and the location information being obtained sequentially in time and made to correspond with each other in time; and a control unit (210) that sends the standard definition image data, stored in the image data storage unit (204, 205), to the image enlargement unit (207) sequentially in time in response to received reproduction instruction information (RP) and, at the same time, supplies the partial image data and the location information, stored in the image data storage unit (204, 205), to the image combination unit (208) sequentially in time.

According to this embodiment, because the whole monitor image is serially stored as standard definition image data and a new object image is serially stored as high definition image data, a new object can be enlarged and reproduced without decreasing the resolution while reducing the amount of stored image data.

In a preferred embodiment of the present invention, when a plurality of new objects are detected in the monitor area, the object detection/extraction unit (202) extracts a plurality of pieces of partial image data in a plurality of areas, each of which contains one of the plurality of new objects, from the high definition image data and obtains a plurality of pieces of location information on the high definition image data of the plurality of pieces of partial image data.

According to this embodiment, even if a plurality of new objects appear in the monitor area, the new objects can be enlarged and reproduced with one high definition camera without decreasing the resolution.

In a preferred embodiment of the present invention, the monitor system further comprises a partial image data down-sampling unit (213a, 213b) that down-samples the partial image data, obtained by the object detection/extraction unit (202) at each predetermined time, at a plurality of predetermined rates and stores the down-sampled partial image data in the image data storage unit (204, 205), wherein, in response to enlargement rate information included in the enlargement instruction information (EL), the control unit (210) selects one of the plurality of pieces of partial image data stored in the image data storage unit (204, 205) and corresponding in time to the enlargement instruction information and supplies the selected one piece of partial image data to the image combination unit (208).

According to this embodiment, a new object can be reproduced at one of a plurality of predetermined enlargement rates without decreasing the resolution.

To solve the above objects, there is provided a monitor system comprising: a remote terminal (4) which is connected to a network (3) and has a display screen where image data is displayed and from which enlargement instruction information (EL) is entered; a high definition camera (1) that photographs a whole monitor area for capturing the photographed whole monitor area as high definition image data higher in resolution than the display screen; an object detection/extraction unit (202) that detects a new object in the monitor area based on the high definition image data captured by the high definition camera (1), extracts partial image data of an area, which contains the new object, from the high definition image data, and obtains location information on the partial image data in relation to the high definition image data; a whole image data down-sampling unit (203) that down-samples the high definition image data to produce standard definition image data corresponding to the resolution of the display screen; an image enlargement unit (207) that enlarges the standard definition image data based on the enlargement instruction information (EL) entered from the remote terminal (4) via the network (3); an image combination unit (208) that overlaps the partial image data on image data, enlarged by the image enlargement unit (207), based on the location information; and a sending unit (312) that sends image data, obtained by the image combination unit (208), to the remote terminal (4) via the network (3).

According to the present invention, one high definition camera can be used to view the image of the whole monitor area in the normal operation status and, as necessary, to enlarge and view a partial area, especially, a new object, without decreasing the resolution. In addition, even a security guard at a place remote from the monitor area can view a new object image while requesting to enlarge the image.

In a preferred embodiment of the present invention, the object detection/extraction unit (202) obtains the partial image data and the location information at each predetermined time and the whole image data down-sampling unit (203) obtains the standard definition image data at the each predetermined time, and the remote terminal (4) sends entered reproduction instruction information (RP) via the network (3), and the monitor system further comprises: an image data storage unit (204, 205) in which the standard definition image data, the partial image data, and the location information are stored, the standard definition image data, the partial image data, and the location information being obtained sequentially in time and made to correspond with each other in time; and a control unit (210) that sends the standard definition image data, stored in the image data storage unit (204, 205), to the image enlargement unit (207) sequentially in time in response to the reproduction instruction information (RP) and, at the same time, supplies the partial image data and the location information, stored in the image data storage unit (204, 205), to the image combination unit (208) sequentially in time.

According to this embodiment, because the whole monitor area image is serially stored as standard definition image data and a new object image is serially stored as high definition image data, the new object can be enlarged and reproduced without decreasing the resolution while reducing the amount of stored image data. In addition, even a security guard at a place remote from the monitor area can send a reproduction instruction and reproduce a new object image while requesting to enlarge the image.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a diagram showing the configuration of a first embodiment of a monitor system of the present invention;

FIG. 2 is a diagram showing how a plurality of detected new objects are tracked with red frames;

FIG. 3 is a diagram showing combined image data;

FIG. 4 is a diagram showing image reproduction processing;

FIGS. 5A and 5B are diagrams showing monitor cameras;

FIG. 6 is a diagram showing monitor cameras;

FIG. 7 is a diagram showing the configuration of a second embodiment of a monitor system of the present invention;

FIG. 8 is a diagram showing an example of processing in the second embodiment;

FIG. 9 is a diagram showing the configuration of a third embodiment of a monitor system of the present invention;

FIG. 10 is a diagram showing an example of processing in the third embodiment; and

FIG. 11 is a diagram showing the configuration of a fourth embodiment of a monitor system of the present invention.

### DESCRIPTION OF THE PREFERRED EMBODIMENTS

Embodiments of a monitor system according to the present invention will be described below in detail with reference to the drawings.

### First Embodiment

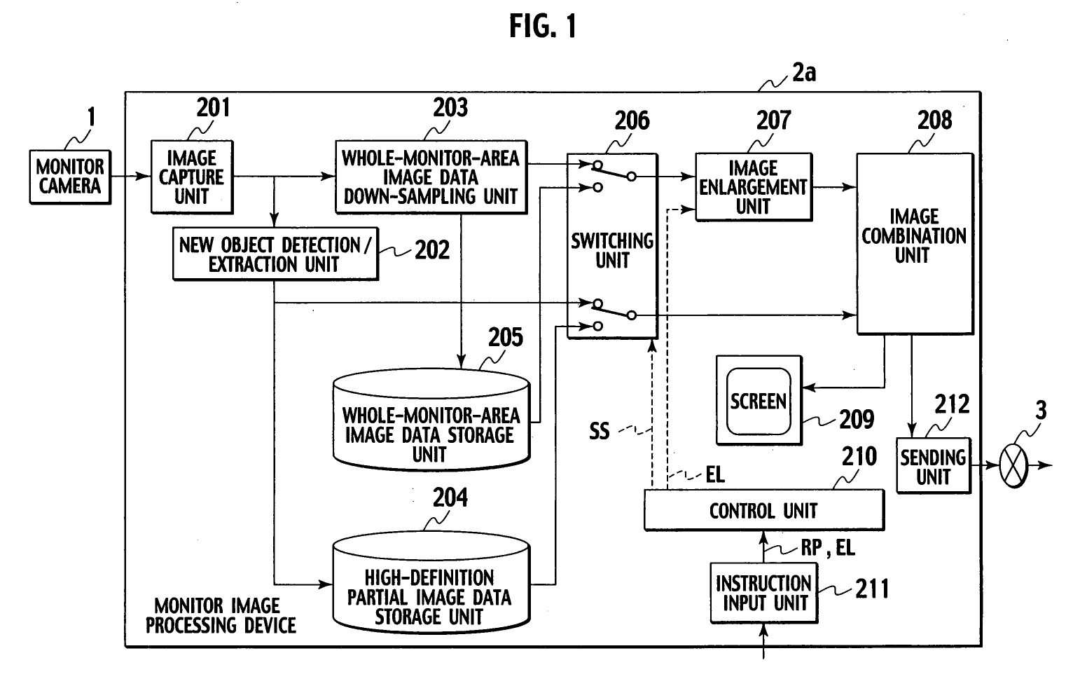

FIG. 1 is a diagram showing the configuration of a first embodiment of the monitor system according to the present invention.

The monitor system in the first embodiment comprises a monitor camera 1 that can photograph a monitor area and acquire the photographed data as high definition image data (1024 horizontal dots×768 vertical dots, 1600 horizontal dots×1200 vertical dots, 3200 horizontal dots×2400 vertical dots, etc.); and a monitor image processing device 2a that processes high definition image data, sent from the monitor camera 1, and displays it on display means.

The monitor image processing device 2a comprises an image capture unit 201 that captures high definition image data from the monitor camera 1; a new object detection/extraction unit 202 that detects a new object in a monitor area based on the high definition image data sent from the image capture unit 201, extracts the partial image data of an area, which contains a new object, from the high definition image data, and acquires location information and size information (these are also called scene description data) on the partial image in relation to the whole-monitor-area image; and a whole-monitor-area image data down-sampling unit 203 that thins out (down samples) high definition image data, received from the image capture unit 201, to acquire standard definition image data corresponding to the resolution of a display screen 209 (NTSC level or VGA level), which will be described later, or a lower resolution.

The monitor image processing device 2a further comprises a high-definition partial image data'storage unit 204 in which partial image data, extracted by the new object detection/extraction unit 202, and location information corresponding to the partial image data are stored; and a whole-monitor-area image data storage unit 205 in which standard definition image data, obtained by the whole-monitor-area image data down-sampling unit 203, is stored.

The monitor image processing device 2a further comprises a switching unit 206 that, in response to a switching signal SS from a control unit 210 which will be described later, selectively switches between partial image data from the new object detection/extraction unit 202 and partial image data from the high-definition partial image data storage unit 204 for receiving one of them and, at the same time, selectively switches between standard definition image data from the whole-monitor-area image data down-sampling unit 203 and standard definition image data from the whole-monitor-area image data storage unit 205 for receiving one of them; an image enlargement unit 207 that enlarges standard definition image output from the switching unit 206; an image combination unit 208 that combines image data by overlapping partial image data, received from the switching unit 206, on an image enlarged by the image enlargement unit 207; and a display screen 209 on which an image output from the image combination unit 208 is displayed.

The monitor image processing device 2a further comprises an instruction input unit 211 from which an operation instruction (enlargement instruction, reproduction instruction) is input by an operator (security guard); a control unit 210 that generally controls the monitor image processing device 2a and, in response to an enlargement instruction signal EL and a reproduction instruction signal RP from the instruction input unit 211, outputs the switching signal SS to the switching unit 206 or outputs the enlargement instruction signal EL to the image enlargement unit 207; and a sending unit 212 that sends image data, output from the image combination unit 208, to a network 3.

Next, the following describes the operation of the monitor system in the first embodiment.

(Real-Time Processing)

First, real-time processing will be described.

When no new object appears during real-time processing (that is, normal status), high definition image data received from the monitor camera 1 is converted (down sampled) to standard definition image data by the whole-monitor-area image data down-sampling unit 203. The converted image data is neither enlarged by the image enlargement unit 207 nor has partial image data overlapped thereon by the image combination unit 208, and is displayed directly on the display screen 209 in real time. At this time, the standard definition image data obtained by the whole-monitor-area image data down-sampling unit 203, as well as frame numbers, is stored in the whole-monitor-area image data storage unit 205, one frame at a time.

Next, assume that a new object appears in the monitor area. When a new object appears, the new object detection/extraction unit 202 calculates the difference between the frames of the image data to detect the new object. By calculating the difference between the frames in this way, the new object can be tracked even if it keeps moving. When a new object is detected, the new object detection/extraction unit 202 determines an area, in which the new object is included, in the monitor area. For example, using a rectangle, the new object detection/extraction unit 202 determines the area in which the new object is included. Because the new object detection/extraction unit 202 determines this area for each frame in this way, the information on the area is serially updated as the time elapses if the new object keeps moving. When the new object detection/extraction unit 202 detects a plurality of new objects, a plurality of areas, for example, rectangles, are determined for the plurality of objects, one for each. Note that a new object may also be detected based on the image down-sampled by the whole-monitor-area image data down-sampling unit 203.

When the new object detection/extraction unit 202 detects a new object in the monitor area in this way, the new object detection/extraction unit 202 notifies the location information and the size information (scene description data) on the rectangular area in relation to the whole monitor area to the image combination unit 208 in the subsequent stage if the system is in the normal operation status. On the other hand, if the enlargement instruction signal EL is sent from the control unit 210 to the image enlargement unit 207 based on the enlargement instruction from the operator (security guard), the new object detection/extraction unit 202 sends the extracted partial image data itself (along with location information in relation to the whole monitor area if it is not included in the data) to the image combination unit 208 in the subsequent stage. An example of location information and size information is the coordinates of the four corners of a rectangle in the whole monitor area.

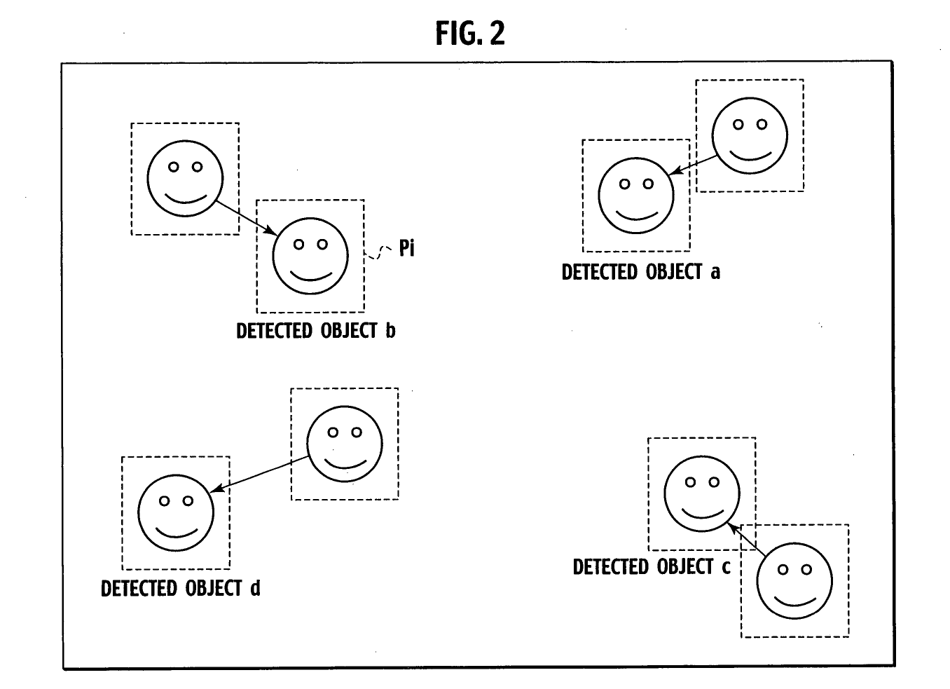

When only the location information and the size information are received, the image combination unit 208 overlaps a frame (for example, a red frame) corresponding to the area, in which the new object is included, on the standard definition image data received from the whole-monitor-area image data down-sampling unit 203. Then, as shown in FIG. 2, a red frame Pi indicating the location of a new object in the whole monitor area is displayed on the display screen 209. If the new object is a moving object, the red frame Pi moves according to the movement of the moving object. If there are a plurality of new objects, a plurality of red frames Pi are displayed. FIG. 2 shows a case in which four moving objects are detected.

On the other hand, if the operator (security guard) wants to identify the new object more in detail and accordingly enters an enlargement instruction from the instruction input unit 211, the image enlargement unit 207 enlarges the standard definition image according to the high definition level of the partial image that is a high definition image. The standard definition image can be enlarged by simple pixel duplication or, if an image as smooth as possible is desired, BiLinear can be used. Based on the location information (scene description data), the image combination unit 208 overlaps the partial image, received from the new object detection/extraction unit 202, on the image enlarged by the image enlargement unit 207. The operator who views an enlarged image displayed on the display screen 209 can shift the displayed image to bring the new object to the center of the screen or, when there are a plurality of new objects, can select one of them for display on the display screen 209. Because those technologies are apparent to those skilled in the art, the description is omitted here. By executing the processing described above, the image of a new object enlarged in size but not decreased in resolution is displayed on the display screen 209.

On the other hand, the same way the whole-monitor-area image data down-sampling unit 203 serially stores standard definition image data, one frame at a time, into the whole-monitor-area image data storage unit 205, the new object detection/extraction unit 202 stores partial image data (which is high definition image data), as well as the location information and the size information (scene description data) on the partial image data in relation to the whole monitor area image, one frame at a time, into the high-definition partial image data storage unit 204 after a new object is detected. When a plurality of new objects are detected, the information is stored for each of the objects. If the size can be identified by the partial image data itself, the size information is not necessary but only the location information is stored.

Although the high-definition partial image data storage unit 204 and the whole-monitor-area image data storage unit 205 are described as separate units in this embodiment, they are only required to be logically separate but may physically share one device such as a hard disk.

The MPEG4 method can be used for recording partial image data and scene description data. In the MPEG4 method, whole-monitor-area image data and partial image data are recorded as moving image streams synchronizing each other.

On the other hand, it is also possible to record the still image data of each of whole-monitor-area image and partial images, one frame at a time, based on the JPEG, BMP, or other still image format. With this still image recording method, the whole-monitor-area image and partial images can be synchronized relatively easily. However, because inter-frame image data compression cannot be performed as in a moving image compression method such as MPEG or MPEG4, the amount of image data becomes large. In the moving image compression method, audio data can be easily included in a video stream. It should be noted that the present invention is applicable directly to a system where the JPEG 2000 method is used because different compression rates can be set, one compression rate for each area in one frame image.

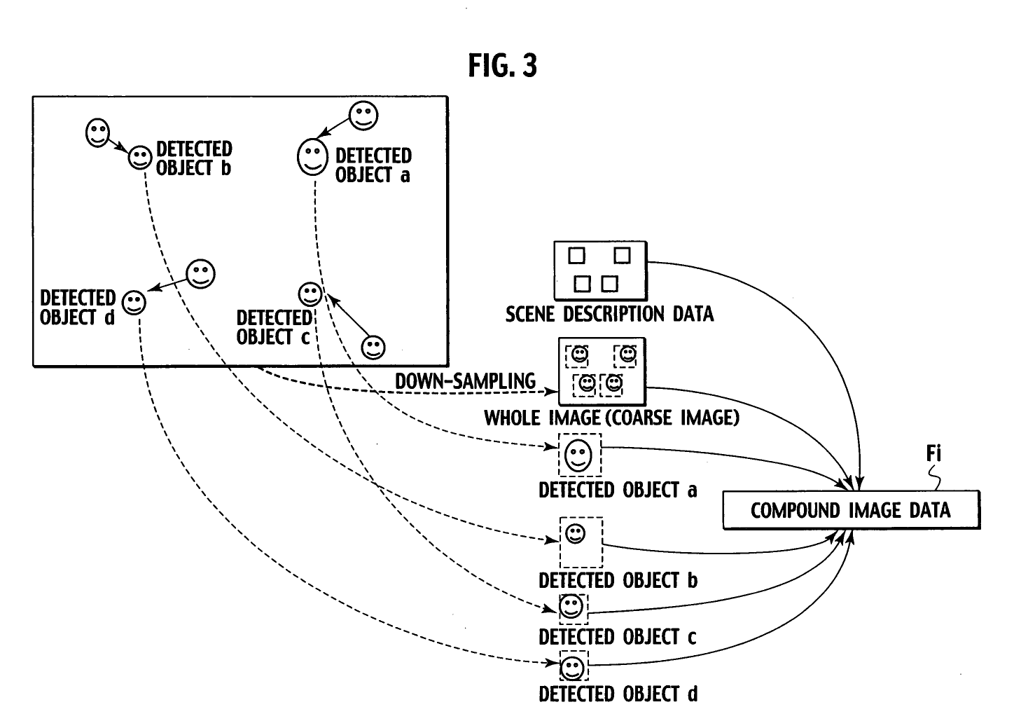

As shown in FIG. 3, whole-monitor-area image data, partial image data, and scene description data can be collectively referred to as compound image data Fi.

In the real-time processing, a security guard can easily identify one or more new objects included in the whole-monitor-area image because they are indicated by the red frame Pi as described above. In addition, a security guard who wants to check a new object more in detail can enlarge the image and view the object in real time without decreasing the resolution. For example, if the new object is a person, the security guard can check the face without decreasing the resolution.

(Reproduction Processing)

Next, the following describes an operation performed when an operator (security guard) issues a reproduction operation request.

The operator who wants to recheck an object that appeared in the monitor area can issue an instruction to the instruction input unit 211 to reproduce the object. In response to the operator's reproduction instruction (including a time to go back to) entered via the instruction input unit 211, the monitor image processing device 2a reproduces an image by going back a specified period of time based on the image data stored in the high-definition partial image data storage unit 204 and the whole-monitor-area image data storage unit 205.

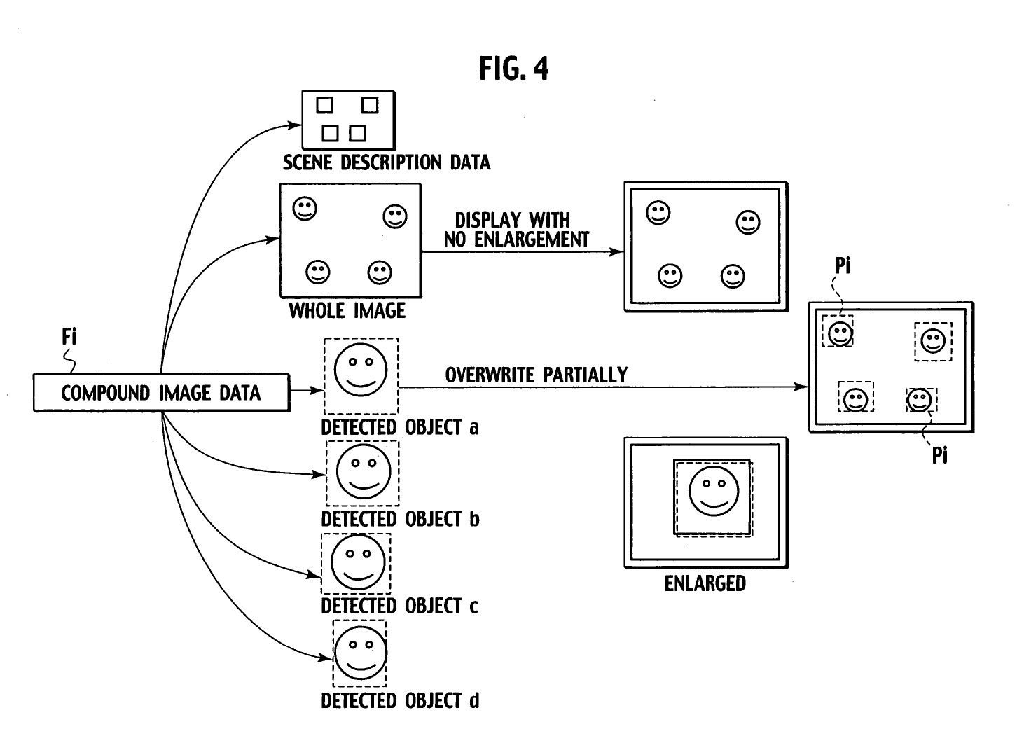

That is, when the operator enters a reproduction instruction from the instruction input unit 211, the control unit 210 issues the switching signal SS to the switching unit 206. In response to the switching signal SS, the switching unit 206 switches itself so that data from the high-definition partial image data storage unit 204 and the whole-monitor-area image data storage unit 205 is output. After that, an image is reproduced from the high-definition partial image data storage unit 204 and the whole-monitor-area image data storage unit 205 by going back the specified period of time. At this time, if the operator does not issue an enlargement instruction, the whole-monitor-area image is displayed on the display screen 209, as shown in FIG. 4, as in the real-time processing described above. After that, when the image changes to the one in which a new object was detected, the red frame Pi is displayed for the detected new object as in the real-time processing described above. That is, the scene description data recorded in the high-definition partial image data storage unit 204 is used.

Next, when the operator issues an enlargement instruction, the control unit 210 issues the enlargement instruction signal EL to the image enlargement unit 207. In response to the enlargement instruction signal EL, the image enlargement unit 207 enlarges the standard definition image according to the high definition level of the partial image as in the real-time processing described above. That is, by using the partial image data that is high definition image data, the new object part can be displayed on the display screen 209 enlarged in size but not decreased in resolution. During the reproduction processing, the new object can be enlarged without decreasing the resolution, but the amount of stored image data is not increased very much.

The real-time processing and the reproduction processing are performed as described above.

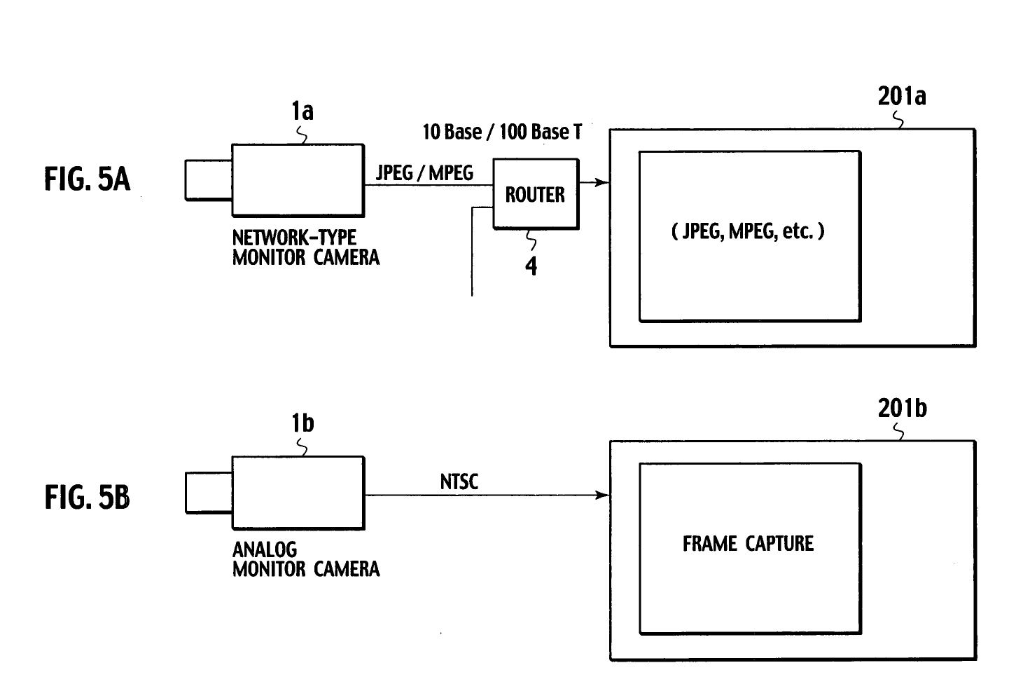

Next, the following describes the monitor camera 1 more in detail. Usually, considering the situation of a place to be monitored, the monitor image processing device 2a is more preferably installed in a place distant from the installation location of the monitor camera 1. In such a case, a network-type monitor camera 1a shown in FIG. 5A is usually used. The network-type monitor camera la is connected to the image capture unit 201 of the monitor image processing device 2a via a router 4. The router 4, to which a plurality of network-type monitor cameras 1a can be connected, selects the network-type monitor camera 1a to be practically connected to the monitor image processing device 2a.

As shown in FIG. 5A, the network-type monitor camera 1a is LAN-connected to, and operates on, a 10BaseT or 100BaseT Ethernet (registered trademark) LAN.

The network-type monitor camera la generally outputs images as continuous, compressed still images most of which use the JPEG image file format, but some network-type monitor cameras compress images based on the MPEG compression technology to output the images as a moving image stream.

Because a video received from the network-type monitor camera 1a is compressed, an image capture unit 201a first decompresses the image before actually starting the image processing according to the present invention.

On the other hand, a conventional high definition analog monitor camera and a high definition digital monitor camera can also be employed. In this case, the compression and decompression of an image is not necessary. FIG. 5B is a diagram showing a system where a high definition analog monitor camera 1b is employed. When the high definition analog monitor camera 1b is employed, an image capture unit 201b captures a frame and converts its data to digital data.

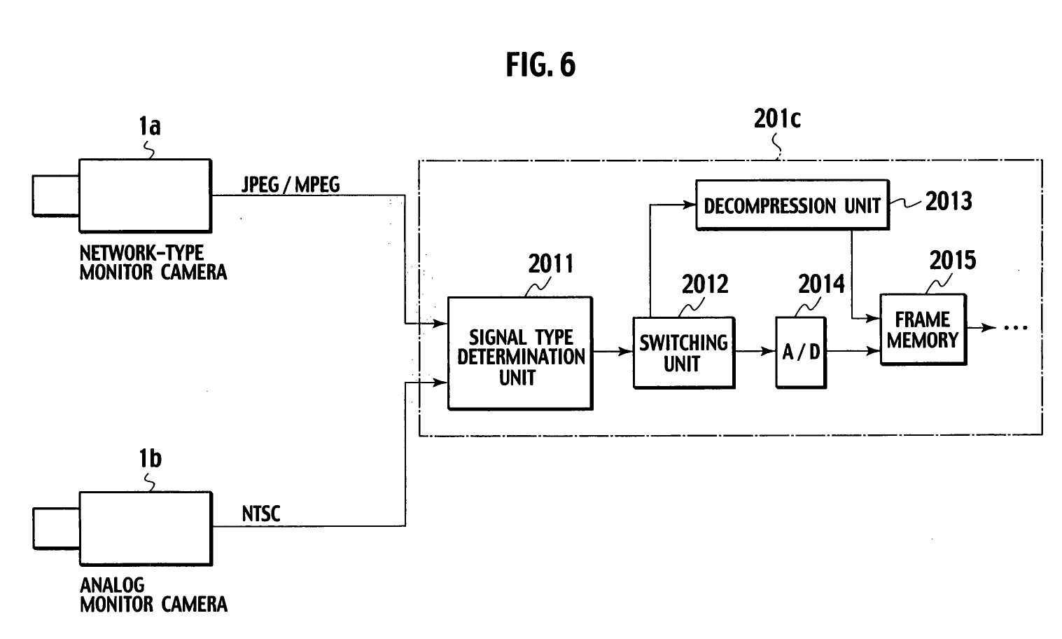

As shown in FIG. 6, it is also possible to connect both the network-type monitor camera 1a and the analog monitor camera 1b. In this case, an image capture unit 201c comprises a signal type determination unit 2011 that determines the signal type, a switching unit 2012, a decompression unit 2013 that performs decompression processing, an A/D conversion unit 2014 that performs analog/digital conversion processing, and a frame memory 2015. That is, when the signal type determination unit 2011 determines that a signal is received from the network-type monitor camera 1a, the switching unit 2012 sends image data to the decompression unit 2013. The decompression unit 2013 decompresses the received compressed image data to restore the image data. In contrast, when the signal type determination unit 2011 determines that a signal is received from the analog monitor camera 1b, the switching unit 2012 sends image data to the A/D conversion unit 2014. The A/D conversion unit 2014 converts the received analog image signal to a digital image signal.

Next, an image output from the image combination unit 208 can be not only displayed on the display screen 209 but also sent to the external network 3 via the sending unit 212. This allows a remote terminal, connected to the network 3, to display an image or to further process the image.

### Second Embodiment

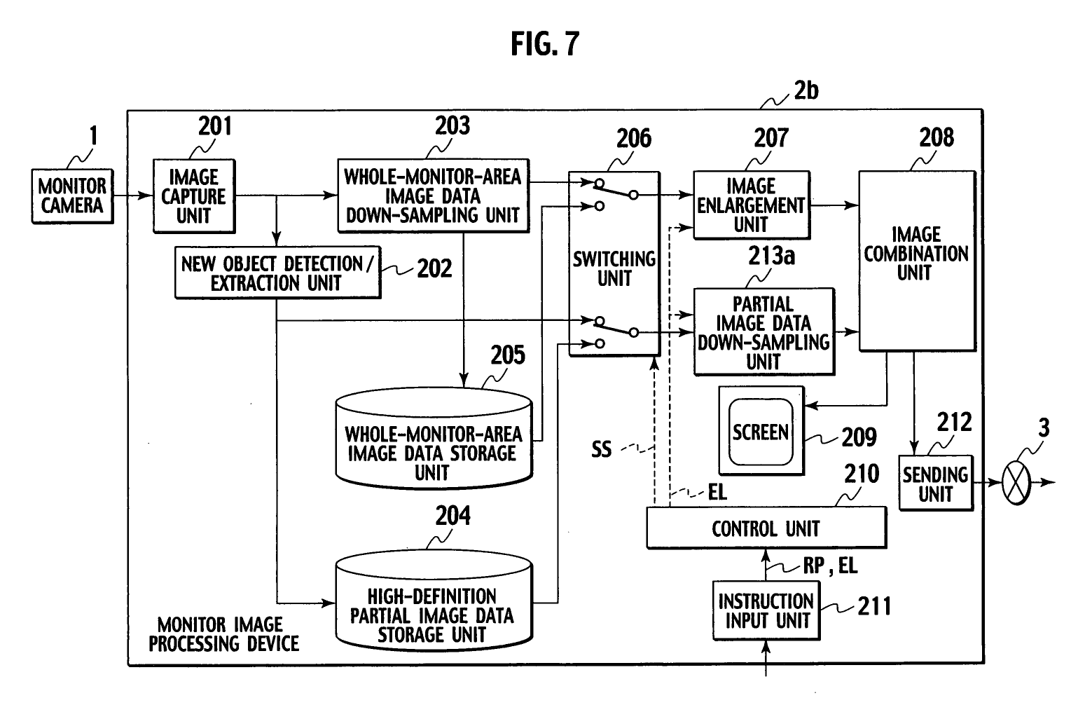

FIG. 7 is a diagram showing the configuration of a second embodiment of a monitor system according to the present invention.

The same reference numeral is used in the configuration shown in FIG. 7 to denote the same element of the configuration shown in FIG. 1, and further description of that element will be omitted.

The configuration of the second embodiment is different from the configuration shown in FIG. 1 in that a partial image data down-sampling unit 213a is added. The partial image data down-sampling unit 213a receives partial image data and scene description data, thins out (down samples) the partial image data, and outputs the processed image data to the image combination unit 208. In addition, the partial image data down-sampling unit 213a receives the enlargement instruction signal EL from the control unit 210.

The following describes the operation more in detail. The description given below is common to both the real-time processing and the reproduction processing.

The first embodiment is designed to maximize the high definition characteristics of partial image data. That is, the image enlargement unit 207 maximizes the standard definition image until it becomes compatible with the resolution of the display screen 209. The maximum enlargement rate is uniquely determined by the relation between the definition level of image data captured by the monitor camera 1 and the resolution of the display screen 209.

In contrast, this embodiment is designed to allow the enlargement rate to be varied. That is, when a lower enlargement rate is desired, the partial image data down-sampling unit 213a can be used to down-sample the partial image data by the desired amount of rate decrease. To do so, the enlargement instruction signal EL is sent also to the partial image data down-sampling unit 213a. That is, as the enlargement rate of the image enlargement unit 207 is decreased, the down-sampling rate of the partial image data down-sampling unit 213a is increased. In the extreme case where the down-scaling rate of the partial image data down-sampling unit 213a is 0, this embodiment is equivalent to the first embodiment. On the other hand, when the enlargement rate of the image enlargement unit 207 is 0 (it maybe assumed that no enlargement instruction is issued), the down-scaling rate of the partial image data down-sampling unit 213a becomes equal to the down-scaling rate of the whole-monitor-area image data down-sampling unit 203, meaning that a new object is not displayed in the high definition image display mode.

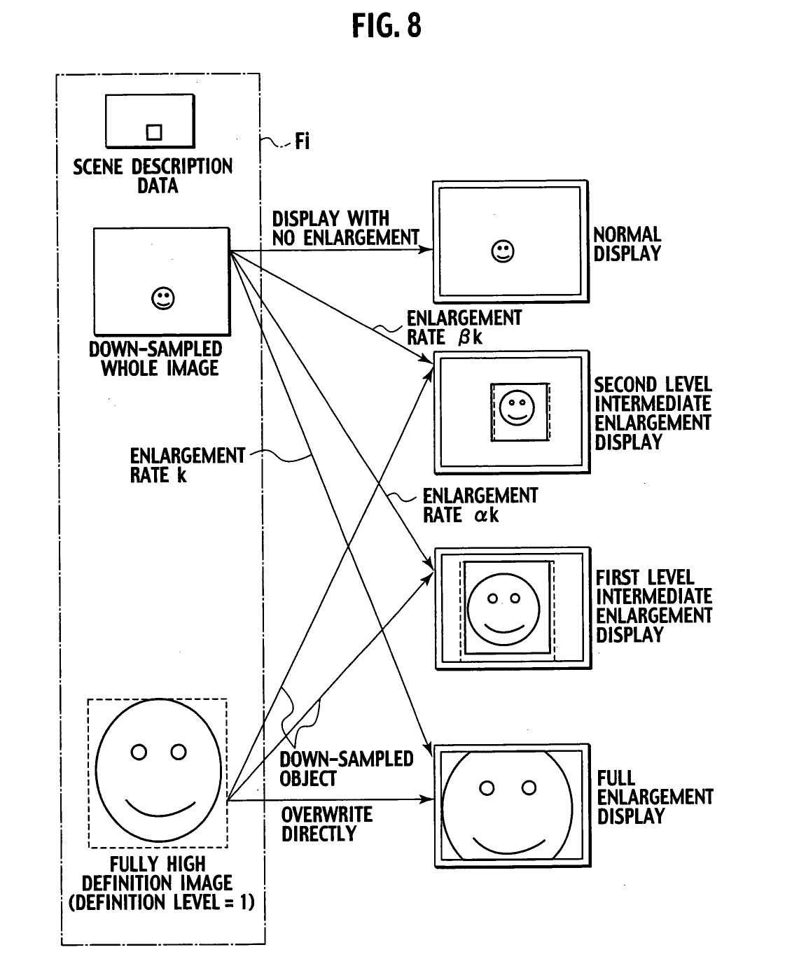

FIG. 8 is a diagram showing an example of processing in the second embodiment. In the description below, it is assumed that the ratio between the definition level of image data captured by the monitor camera 1 and the resolution of the display screen 209 is k:1.

First, when a fully high definition partial image is displayed (as if in the first embodiment), the enlargement instruction signal EL specifying the enlargement rate of k is sent from the control unit 210 to the image enlargement unit 207 and the partial image data down-sampling unit 213a. At this time, the image enlargement unit 207 enlarges the whole-monitor-area image at the enlargement rate of k. On the other hand, the partial image data down-sampling unit 213a sends the high definition image, received from the new object detection/extraction unit 202 or the high-definition partial image data storage unit 204, to the image combination unit 208 without down sampling. Therefore, in the image combination unit 208, the whole image fully enlarged by the image enlargement unit 207 and the fully high definition partial image received from the partial image data down-sampling unit 213a are combined and, therefore, the new object is displayed on the display screen 209 in the full enlargement display mode.

Next, assume that the enlargement instruction signal EL specifying the enlargement rate of αk (0<α<1, 1<αk) is sent from the control unit 210 to the image enlargement unit 207 and the partial image data down-sampling unit 213a. In response to this signal, the image enlargement unit 207 enlarges the whole-monitor-area image at the enlargement rate of αk. Assuming that the definition level of a fully high definition image is 1, on the other hand, the partial image data down-sampling unit 213a down-samples the partial image to output a new definition image (first level intermediate definition image) so that its definition level becomes α. Therefore, in the image combination unit 208, the whole image enlarged by the image enlargement unit 207 at the enlargement rate of αk and the partial image of the first level intermediate definition received from the partial image data down-sampling unit 213a are combined and, thus, the new object is displayed on the display screen 209 in the first level intermediate enlargement display mode.

Next, assume that the enlargement instruction signal EL specifying the enlargement rate of βk (0<β<1, β<α, 1<βk) is sent from the control unit 210 to the image enlargement unit 207 and the partial image data down-sampling unit 213a. In response to this signal, the image enlargement unit 207 enlarges the whole-monitor-area image at the enlargement rate of βk. On the other hand, the partial image data down-sampling unit 213a down-samples the partial image to output a new definition image (second level intermediate definition image) so that its definition level becomes β. Therefore, in the image combination unit 208, the whole image enlarged by the image enlargement unit 207 at the enlargement rate of βk and the partial image of the second level intermediate definition received from the partial image data down-sampling unit 213a are combined and, thus, the new object is displayed on the display screen 209 in the second level intermediate enlargement display mode.

As described above, a partial image can also be displayed in the high definition mode according to a variable enlargement rate. Although two types of intermediate enlargement are described above, any enlargement rate ranging from 1 to k may theoretically be used.

### Third Embodiment

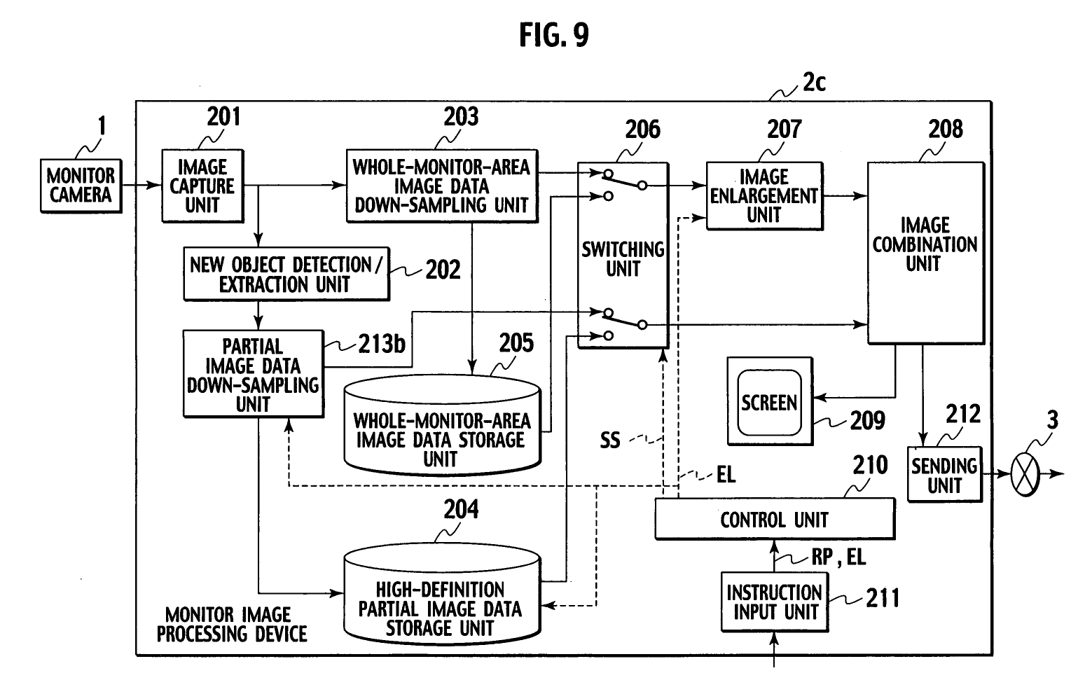

FIG. 9 is a diagram showing the configuration of a third embodiment of a monitor system according to the present invention.

The same reference numeral is used in the configuration shown in FIG. 9 to denote the same element of the configurations shown in FIG. 1 and FIG. 7, and further description of that element will be omitted.

In the second embodiment, the configuration where a continuously varying enlargement rate can be used is described. In that configuration, the high-definition partial image data storage unit 204 stores fully high definition images and, when an image is reproduced, a fully high definition image from the high-definition partial image data storage unit 204 is down-sampled according to a specified enlargement rate and is overlapped on an enlarged whole image.

In contrast, a third embodiment has a configuration where the enlargement rate is one of the predetermined values. That is, a partial image data down-sampling unit 213b is in a stage after the new object detection/extraction unit 202 and before the high-definition partial image data storage unit 204 and the switching unit 206. In addition, the enlargement instruction signal EL is sent also to the partial image data down-sampling unit 213b and the high-definition partial image data storage unit 204. In the description below, assume that the enlargement rate can be selected only from the following three: k, αk, and βk.

In the real-time processing, the partial image data down-sampling unit 213b, which receives the enlargement instruction signal EL from the control unit 210, sends one of the following partial images to the image combination unit 208 via the switching unit 206: fully high definition partial image data itself, a down-sampled first level intermediate definition image (definition level=α), and a down-sampled second level intermediate definition image (definition level=β). The processing of the image enlargement unit 207 and the image combination unit 208 is the same as that in the second embodiment.

In parallel to the real time processing, partial image data at three definition levels (fully high definition, first level intermediate definition, and second level intermediate definition) is stored in the high-definition partial image data storage unit 204, one frame at a time.

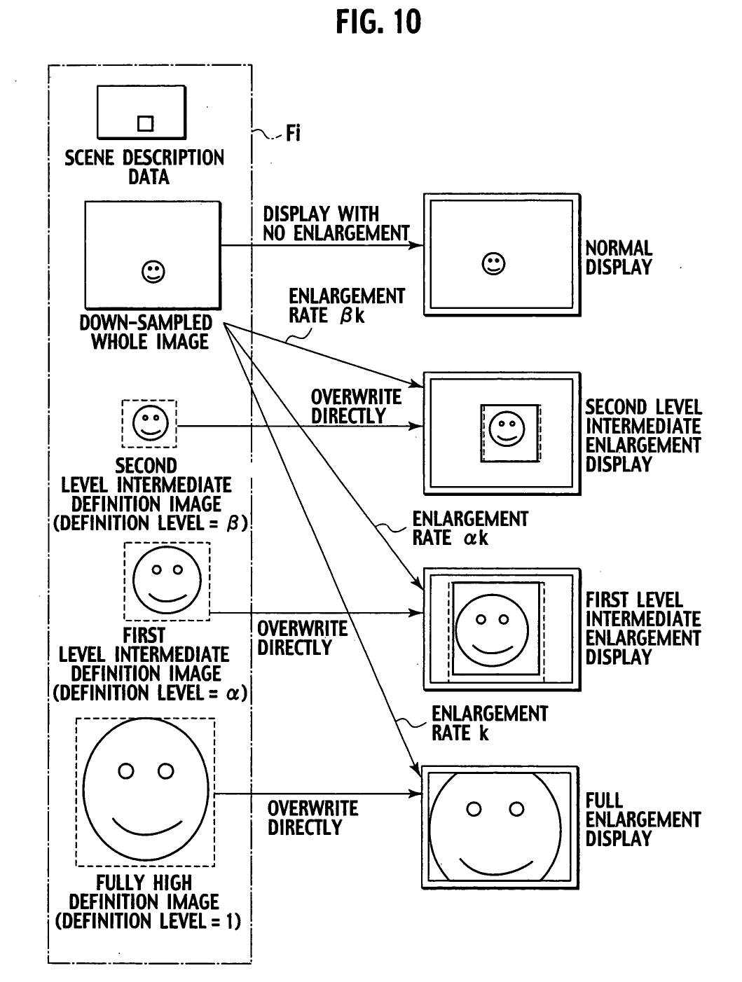

FIG. 10 is a diagram showing an example of processing in a third embodiment. In the description below, there are three enlargement rates, k, αk, and βk, as described above.

In the reproduction processing, the high-definition partial image data storage unit 204 outputs one of a fully high precision image, a first level intermediate definition image, and a second level intermediate definition image according to the enlargement rate indicated by the enlargement instruction signal EL received from the control unit 210 (This description is for convenience. In practice, the control unit 210 reads desired data from the high-definition partial image data storage unit 204 according to the enlargement rate). The processing of the image enlargement unit 207 and the image combination unit 208 is the same as that in the second embodiment.

If the enlargement rates are pre-fixed as described above, it is also possible to store definition image data in the high-definition partial image data storage unit 204 according to the enlargement rates.

### Fourth Embodiment

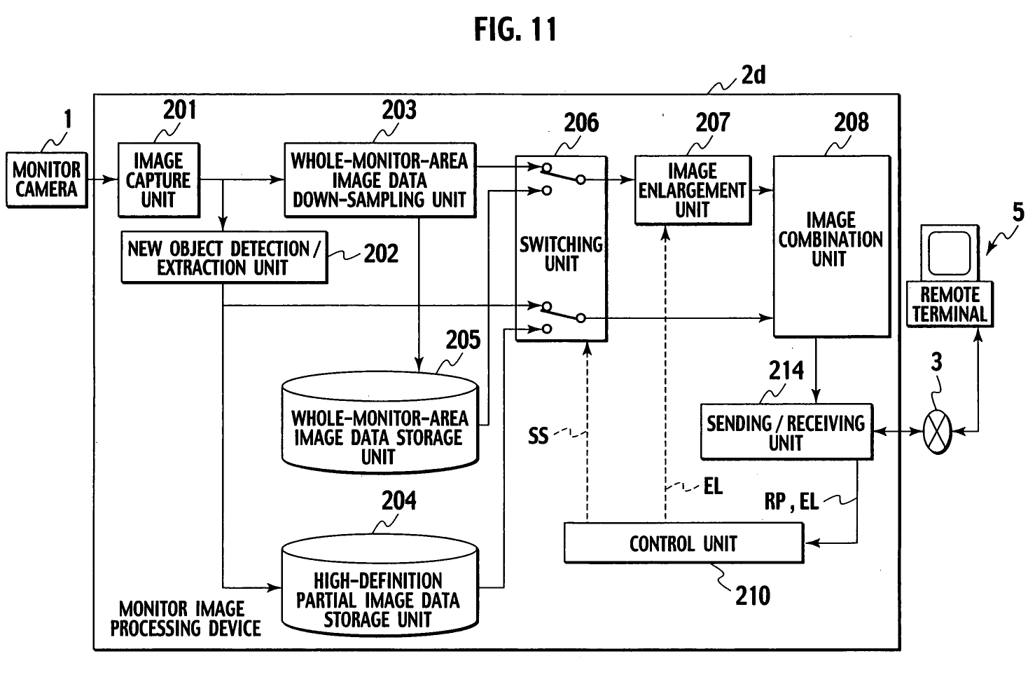

FIG. 11 is a diagram showing the configuration of a fourth embodiment of a monitor system according to the present invention.

The same reference numeral is used in the configuration shown in FIG. 11 to denote the same element of the configuration shown in FIG. 1, and further description of that element will be omitted.

The fourth embodiment shown in FIG. 11 does not have the display screen 209 or the instruction input unit 211 but, instead, has a remote terminal 5 connected to the network 3. That is, the operator (security guard) is at the location of the remote terminal 5 and issues a reproduction instruction or an enlargement instruction via the remote terminal 5. The reproduction instruction or the enlargement instruction entered from the remote terminal 5 in this way is input to a sending/receiving unit 214 of a monitor image processing device 2d via the network 3. The sending/receiving unit 214 sends the received reproduction instruction signal RP and the enlargement instruction signal EL to the control unit 210. As in the first embodiment, the control unit 210 sends the switching signal SS to the switching unit 206, and the enlargement instruction signal EL to the image enlargement unit 207. The subsequent processing is the same as that in the first embodiment.

The image data produced by the image combination unit 208 is not displayed on the monitor image processing device 2d but is sent to the sending/receiving unit 214. The sending/receiving unit 214 sends the image data to the remote terminal 5 via the network 3. Therefore, the image of the image data is displayed on the display screen of the remote terminal 5. In this case, the sending/receiving unit 214 should preferably compress image data before sending it.

As described above, the real-time processing and the reproduction processing similar to those in the first embodiment can be performed in the fourth embodiment via the remote terminal 5.

It should be understood that many modifications and adaptations of the invention will become apparent to those skilled in the art and it is intended to encompass such obvious modifications and changes in the scope of the claims appended hereto.

1. A monitor system comprising:
a display screen on which image data is displayed;
a high definition camera that photographs a whole monitor area for capturing the photographed whole monitor area as high definition image data higher in resolution than said display screen;
an object detection/extraction unit that detects a new object in the monitor area based on the high definition image data captured by said high definition camera, extracts partial image data of an area, which contains the new object, from the high definition image data, and obtains location information on the partial image data in relation to the high definition image data;
a whole image data down-sampling unit that down-samples the high definition image data to produce standard definition image data corresponding to the resolution of said display screen;
an image enlargement unit that enlarges the standard definition image data based on entered enlargement instruction information; and
an image combination unit that overlaps the partial image data on image data, enlarged by said image enlargement unit, based on the location information and sends resulting image data to said display screen.

2. The monitor system according to claim 1 wherein, when a plurality of new objects are detected in the monitor area, said object detection/extraction unit extracts a plurality of pieces of partial image data in a plurality of areas, each of which contains one of the plurality of new objects, from the high definition image data and obtains a plurality of pieces of location information on the high definition image data of the plurality of pieces of partial image data.

3. The monitor system according to claim 1 wherein said image enlargement unit enlarges the standard definition image data according to a ratio between a definition level of the high definition image data and the resolution of said display screen.

4. The monitor system according to claim 1, further comprising:
a partial image data down-sampling unit that down-samples the partial image data, extracted by said object detection/extraction unit, and sends the down-sampled partial image data to said image combination unit,
wherein said image enlargement unit enlarges the standard definition image data according to enlargement rate information included in the enlargement instruction information and said partial image data down-sampling unit down-samples the partial image data according to the enlargement rate information.

5. The monitor system according to claim 1 wherein
said object detection/extraction unit obtains the partial image data and the location information at each predetermined time and said whole image data down-sampling unit obtains the standard definition image data at said each predetermined time,
said monitor system further comprising:
an image data storage unit in which the standard definition image data, the partial image data, and the location information are stored, said standard definition image data, said partial image data, and said location information being obtained sequentially in time and made to correspond with each other in time; and
a control unit that sends the standard definition image data, stored in said image data storage unit, to said image enlargement unit sequentially in time in response to received reproduction instruction information and, at the same time, supplies the partial image data and the location information, stored in said image data storage unit, to said image combination unit sequentially in time.

6. The monitor system according to claim 5 wherein, when a plurality of new objects are detected in the monitor area, said object detection/extraction unit extracts a plurality of pieces of partial image data in a plurality of areas, each of which contains one of the plurality of new objects, from the high definition image data and obtains a plurality of pieces of location information on the high definition image data of the plurality of pieces of partial image data.

7. The monitor system according to claim 5, further comprising:
a partial image data down-sampling unit that down-samples the partial image data, obtained by said object detection/extraction unit at each predetermined time, at a plurality of predetermined rates and stores the down-sampled partial image data in said image data storage unit,
wherein, in response to enlargement rate information included in the enlargement instruction information, said control unit selects one of said plurality of pieces of partial image data stored in said image data storage unit and corresponding in time to the enlargement instruction information and supplies the selected one piece of partial image data to said image combination unit.

8. A monitor system comprising:
a remote terminal which is connected to a network and has a display screen where image data is displayed and from which enlargement instruction information is entered;
a high definition camera that photographs a whole monitor area for capturing the photographed whole monitor area as high definition image data higher in resolution than said display screen;
an object detection/extraction unit that detects a new object in the monitor area based on the high definition image data captured by said high definition camera, extracts partial image data of an area, which contains the new object, from the high definition image data, and obtains location information on the partial image data in relation to the high definition image data;
a whole image data down-sampling unit that down-samples the high definition image data to produce standard definition image data corresponding to the resolution of said display screen;
an image enlargement unit that enlarges the standard definition image data based on the enlargement instruction information entered from said remote terminal via said network;
an image combination unit that overlaps the partial image data on image data, enlarged by said image enlargement unit, based on the location information; and
a sending unit that sends image data, obtained by said image combination unit, to said remote terminal via said network.

9. The monitor system according to claim 8 wherein
said object detection/extraction unit obtains the partial image data and the location information at each predetermined time and said whole image data down-sampling unit obtains the standard definition image data at said each predetermined time, and
said remote terminal sends entered reproduction instruction information via said network,
said monitor system further comprising:
an image data storage unit in which the standard definition image data, the partial image data, and the location information are stored, said standard definition image data, said partial image data, and said location information being obtained sequentially in time and made to correspond with each other in time; and
a control unit that sends the standard definition image data, stored in said image data storage unit, to said image enlargement unit sequentially in time in response to the reproduction instruction information and, at the same time, supplies the partial image data and the location information, stored in said image data storage unit, to said image combination unit sequentially in time.
